(19) United States
(12) Patent Application Publication
(10) Pub. No.: US 2005/0017055 A1
(43) Pub. Date: Jan. 27, 2005

(54) Electrochemical fuel cell component materials and methods of bonding electrochemical fuel cell components

(76) Inventors: Douglas L. Kurz, Sands Point, NY (US); Clifford W. Campbell, Massapequa, NY (US); Sergio P. De Albuquerque, Garden City, NY (US)

Correspondence Address: KENYON & KENYON, ONE BROADWAY, NEW YORK, NY, 10004, US

(21) Appl. No.: 10/627,239

(22) Filed: Jul. 24, 2003

(51) Int. Cl. H01M 8/02; B32B 15/02

(52) U.S. Cl. 228/194; 429/34; 428/615

(57) ABSTRACT

A method of producing a porous flow field material for a bipolar separator plate is provided. The method includes bonding a single layer of wire mesh or bonding together at least two layers of wire mesh to form a porous flow field material, wherein the bonding is achieved by diffusion bonding, continuous resistance welding, continuous sintering, or a combination thereof. Such porous flow filed materials may function as, for example, fluid flow fields, current collectors, gas distribution layers, and/or coolant layers. A method of producing a bipolar separator plate including such porous flow field materials is also provided, wherein the component layers are bonded together by diffusion bonding, continuous resistance welding, continuous sintering, or a combination thereof, thereby forming a bipolar separator plate.

### FIELD OF THE INVENTION

The present invention relates to electrochemical fuel cells generally, and more particularly those incorporating a particular class of metallurgically bonded component materials, and a method of metallurgically bonding certain electrochemical fuel cell component materials.

### BACKGROUND OF THE INVENTION

By means of a catalyzed electrochemical reaction, electrochemical fuel cells convert a fuel, such as hydrogen or methanol, and an oxidant into electricity and other byproducts, such as water. One class of conventional designs for an electrochemical fuel cell typically includes a “stack” or assembly that comprises two types of components stacked vertically in an alternating sequence. One type of component is a thin flat article known as a membrane electrode assembly (“MEA”), while the other type of component is an interposed plate known variously as a separator plate, a bipolar plate, a bipolar separator plate, or a fluid flow field plate. The separator plates perform a variety of functions, which account for the various names applied to them. Successive layers of MEA are interleaved between successive bipolar separator plates to create the alternating sequence that forms the fuel cell stack.

The MEA typically includes a proton (hydrogen ion) exchange membrane (“PEM”), or more particularly a solid polymer electrolyte membrane such as E.I. DuPont de Nemours & Co., Inc.'s Nafion® perfluorinated polymer membrane. Any fuel cell incorporating MEA's based on a PEM is commonly referred to as a PEM fuel cell, or a “PEMFC.” There are also other fuel cell designs, such as a solid oxide fuel cell, or a “SOFC.”

In the MEA, the PEM or proton exchange membrane is sandwiched between thin wafers of electrically conductive sheet material that function as electrodes. The electrodes may typically be composed of a carbon or graphite material, such as Union Carbide's Grafoil®, or a metal matrix or other substrate impregnated with carbon or graphite or other suitable electrode material. The electrodes may also contain a suffused, distributed, plated or otherwise incorporated catalyst such as platinum. The electrodes may also have surface treatments to reduce contact resistivity between the planar electrode surfaces and the contiguous and tangent separator plate.

The separator plate, as alluded to above, must be capable of performing a variety of functions. That is, the separator plate provides for physical separation between successive MEA's, and provides mechanical support across the planar surface of the MEA. The separator plate is also electrically bipolar, i.e., it provides two separate contact surfaces to the MEA's: a cathode side to contact the positive electrode (cathode) of the MEA on one side of the separator plate, and an anode side to contact the negative electrode (anode) of another MEA on the second side of the separator plate. In addition, the separator plate also provides fluid flow fields to allow the flow and distribution of gaseous reactants such as hydrogen or methanol to the MEA anode and air or oxygen to the MEA cathode, and to allow the flow and collection of reaction byproducts such as electrical current and water vapor from the MEA cathode.

The bipolar separator plate is preferably a thin article with dimensions approximately similar to those of the membrane electrode assemblies, so that it achieves an acceptably high ratio of current collecting capacity to volume, or current density. It is preferably smooth and burr-free so as not to damage the contacting surfaces of the tangent MEA. The bipolar separator plate is preferably not brittle, and can withstand various impact forces without cracking or breaking and thereby leaking hydrogen or other substances. The plate preferably provides uniform planar support of the MEA at all points to a fine degree of resolution.

The bipolar separator plate must preferably combine all of these functions within one repeatable low-cost design. In order to achieve all of these engineering objectives, a bipolar separator plate may be constructed as an assembly of various thin wafer-like layers and components, suitably designed with inlet and outlet ports for various reaction components and products.

In a simple bipolar separator plate design, a metal foil provides a layer of separation between porous fluid flow fields on either side. Thus, the structure in cross-section is essentially A-B-A, wherein “A” represents a porous flow field or gas distribution layer, while “B” represents a solid shim or gas barrier layer. In a more complex design, a third flow field “C” occupies a central position thusly: A-B-C-B-A. In this design, the central layer “C” is a porous fluid flow field that functions as a coolant layer, which may allow the flow of a recirculating coolant within the bipolar separator plate structure.

To date, a wide variety of materials have been employed for the production of bipolar separator plates. The earliest materials used included pressed or molded carbon materials, which were used in phosphoric acid fuel cells (“PAFC”) which preceded PEM cells. The bipolar separator plates made therewith were often thick and heavy, expensive and subject to breakage. Later, more sophisticated forms of graphite-based bipolar plate components and other non-metallic materials were developed, including polymers as well as composite materials. These materials reduced cost and volume, thereby increasing volumetric current density. Various structures primarily including graphite particles or fibers, or reticulated structures described as carbon foams or graphite foams, were popularly preferred. More recently, however, a greater focus has been applied to metallic materials.

For example, reticulated metallic structures such as porous metal foam have been used in the production of electrochemical fuel cells. For instance, U.S. patent application Publication No. 2001/0033956 to Appleby et al. discloses a “fuel cell component comprising a porous metal flow field, an intermediate layer bonded directly to the porous metal flow field, and an electrode bonded directly to the intermediate layer,” wherein the porous metal flow field structure is a three-dimensional reticulated metal foam. U.S. patent application Publication No. 2001/0033956, paragraphs 20 and 76-77.

Other metallic structures such as thin layers of randomly laid and bonded metal fibers or metal powders have also been employed in the production of electrochemical fuel cells. In such an article, the discrete fibers or particles are typically either sinter bonded or adhesive bonded. Such metal fibers or powders may be pure metals or alloys thereof. Expanded, lanced, punched, perforated or otherwise pierced metal grids, and photo-etched metal foils have been used, as well as combinations of the above structures, such as composites of metal powder particles and fibers.

Single layers of woven wire mesh or gauze have also been used in the production of electrochemical fuel cells. For example, U.S. Pat. No. 6,037,072 to Wilson et al. discloses a bipolar plate including “a thin metal foil having an anode side and a cathode side; a first metal mesh on the anode side of the thin metal foil; and a second metal mesh on the cathode side of the thin metal foil.” U.S. Pat. No. 6,037,072, col. 3, lines 31-34. According to Wilson et al., the metal meshes define a flow-field pattern, and sit within a gasket frame which is applied to the thin metal foil. See U.S. Pat. No. 6,037,072, col. 7, lines 10-27.

Different bonding methods have been employed in the production of electrochemical fuel cells. Such methods include adhesive bonding, and bonding using a non-metallic bonding agent. In addition, bonding methods that do not incorporate a non-metallic agent have been employed, including those methods in which a metal filler material is added, as well as methods in which no such metal filler material is added.

For example, bonding methods involving the addition of a metal filler material include torch brazing, furnace brazing, dip brazing, soldering, or welding with a filler metal. In the case of brazing or soldering the filler metal may be plated on, incorporated as a pre-form shim or wire, or applied as a paste or feed wire before or during bonding. For example, in U.S. patent application Publication No. 2003/0003343 to Cisar et al., a method of bonding electrochemical cell components is disclosed, wherein the bonding is achieved either via adhesives when polymer and/or metallic components are involved, or via soldering when only metallic components are involved. In addition, in U.S. patent application Publication No. 2002/0055028 to Ghosh et al., a method of brazing together three stainless steel plates to form an electrochemical cell interconnect is disclosed. However, the use of a metal filler material is generally not desirable, as it may not have the strength or corrosion resistance of the base metals being joined. Additionally, more labor, cost, volume and weight are added when a metal filler material is used.

Bonding methods not involving the addition of a metal filler material include seal or fusion welding, tack welding, resistance spot welding, resistance seam welding, laser or electron beam welding, cladding by application of severe pressure, and high temperature sintering. For example, U.S. patent application Publication No. 2001/0004050 to Byron et al. discloses an integrated screen and protector edge for use in an electrochemical cell wherein the integrated screen and protector edge is assembled via a tack weld process.

In U.S. Pat. No. 6,232,010 to Cisar et al., a unitized barrier and flow control device for electrochemical reactors is disclosed. The device includes “a porous metal flow field having a first face and a porous metal gas diffusion layer metallurgically bonded to the first face of the porous metal flow field.” U.S. Pat. No. 6,232,010, col. 4, lines 56-59. Furthermore, “the porous metal flow field is selected from metal foam, expanded metal sheet, sintered metal particles or sintered metal fibers and the porous metal gas diffusion layer is selected from sintered metal particles or sintered metal fibers. The metallurgical bonds are formed by a process selected from welding, brazing, soldering, sintering, fusion bonding, vacuum bonding, or combinations thereof.” U.S. Pat. No. 6,232,010, col. 5, lines 2-9.

The previously described metal structures have been produced or proposed in a variety of metals and alloys, including austenitic or other stainless steels or ferrous alloys, and nickel, titanium, copper, aluminum, magnesium and other metals and their alloys. In addition to permeability and conductivity, corrosion resistance and chemical compatibility with the PEM membrane have been evaluated for such metals and alloys. For reasons of economy and practicality, an austenitic stainless steel is commonly employed as the alloy of construction for a bipolar separator plate, as an austenitic stainless steel offers excellent corrosion resistance, availability, manufacturability, and low cost.

However, the previously described metal structures, whether produced in stainless steel or other alloys, are found wanting in certain of the various desired characteristics. Many of the structures, including reticulated metallic and non-metallic foams, as well as most fiber or powder matrix or composite media embody a randomized architecture. Reticulated foams exhibit a random topology of interconnected solid material, which defines a complementary space of connected void volumes. Fiber matrices also comprise randomly oriented and positioned component fibers.

In theory, by optimizing the “randomization” of fiber positions within a fiber matrix, or by optimizing the manufacturing process for creating reticulated metal foam, it is possible to create a “uniformly random” architecture (i.e., one that is isotropic and homogeneous). However, perfect isotropy is not attainable, and the resultant topologies, while possibly exhibiting characteristics that are globally controlled within desired parameters, are often locally anisotropic within a broader bell curve distribution of pore sizes and configurations. Furthermore, no two sheets of truly random media are ever geometrically or topologically identical, and so the objective of perfect repeatability in the manufacturing process may not be truly attainable even with adequate process and quality control. A further problem with these previously produced structures is the potential for shedding of fibers or particles.

Thus, there is a need in the art for an improved material for producing porous flow fields for bipolar separator plates, which would result in more uniform and homogeneous porous flow fields.

### SUMMARY OF THE INVENTION

An embodiment of the present invention is directed to a method of producing a porous flow field material for a bipolar separator plate. The method comprises positioning at least two layers of woven wire mesh in a stacked arrangement, and bonding together the at least two layers of woven wire mesh to form the porous flow field material, wherein the bonding together is achieved by diffusion bonding, continuous resistance welding, continuous sintering, or a combination thereof. In addition, an additional layer of woven wire mesh, with warp and weft mesh counts which are higher than the warp and weft mesh counts of the at least two layers of woven wire mesh, may be positioned on top of the at least two layers of woven wire mesh such that the at least two layers of woven wire mesh and the additional layer of woven wire mesh are bonded together to form the porous flow field material.

In another embodiment of the present invention directed to a method of producing a porous flow field material, a single layer of woven wire mesh is employed instead of the at least two layers of woven wire mesh. In this embodiment of the invention, a single layer of woven wire mesh including warp wires and weft wires is bonded to form the porous flow field material. The bonding comprises bonding together the warp wires and the weft wires at at least substantially all of their points of contact within the woven wire mesh, and the bonding is achieved by diffusion bonding, continuous resistance welding, continuous sintering, or a combination thereof.

Another embodiment of the present invention is directed to a porous flow field material for a bipolar separator plate comprising at least two layers of woven wire mesh bonded together by a metallurgical bond, wherein the metallurgical bond is formed by diffusion bonding, continuous resistance welding, continuous sintering, or a combination thereof. Furthermore, an additional layer of woven wire mesh, with warp and weft mesh counts which are higher than the warp and weft mesh counts of the at least two layers of woven wire mesh, may be added such that the at least two layers of woven wire mesh and the additional layer of woven wire mesh are bonded together by a metallurgical bond.

In another embodiment of the present invention directed to a porous flow field material for a bipolar separator plate, the porous flow field material comprises a single layer of woven wire mesh including warp wires and weft wires, wherein the warp wires and the weft wires are bonded together by a metallurgical bond at at least substantially all of their points of contact within the woven wire mesh. The metallurgical bond is formed by diffusion bonding, continuous resistance welding, continuous sintering, or a combination thereof.

A further embodiment of the invention is directed to a method of producing a bipolar separator plate. The method comprises positioning at least one gas barrier layer adjacent to at least one porous flow field material, wherein the porous flow field material comprises at least two layers of woven wire mesh bonded together by a metallurgical bond, wherein the metallurgical bond is formed by diffusion bonding, continuous resistance welding, continuous sintering, or a combination thereof. The porous flow field material may optionally include an additional layer of woven wire mesh having warp and weft mesh counts which are higher than the warp and weft mesh counts of the at least two layers of woven wire mesh, such that the at least two layers of woven wire mesh and the additional layer of woven wire mesh are bonded together by the metallurgical bond. The at least one gas barrier layer and the at least one porous flow field material are then bonded together by diffusion bonding, continuous resistance welding, continuous sintering, or a combination thereof.

In another embodiment of the present invention directed to a method of producing a bipolar separator plate, the method comprises positioning at least one gas barrier layer adjacent to at least one porous flow field material, wherein the at least one porous flow field material comprises a single layer of woven wire mesh including warp wires and weft wires, wherein the warp wires and the weft wires are bonded together by a metallurgical bond at at least substantially all of their points of contact within the woven wire mesh. The metallurgical bond is formed by diffusion bonding, continuous resistance welding, continuous sintering, or a combination thereof. The at least one gas barrier layer and the at least one porous flow field material are then bonded together by diffusion bonding, continuous resistance welding, continuous sintering, or a combination thereof.

In addition, the method of producing a bipolar separator plate according to the present invention may optionally be used to include additional components suitably designed to provide inlet and outlet ports for various reactants and reaction by-products.

Another embodiment of the present invention is directed to a bipolar separator plate comprising at least one porous flow field material bonded to at least one gas barrier layer by a metallurgical bond, wherein the metallurgical bond is formed by diffusion bonding, continuous resistance welding, continuous sintering, or a combination thereof. The at least one porous flow field material comprises at least two layers of woven wire mesh bonded together by another metallurgical bond which is formed by diffusion bonding, continuous resistance welding, continuous sintering, or a combination thereof. In addition, the at least one porous flow field material may optionally include an additional layer of woven wire mesh having warp and weft mesh counts which are higher than the warp and weft mesh counts of the at least two layers of woven wire mesh, such that the at least two layers of woven wire mesh and the additional layer of woven wire mesh are bonded together by the latter-mentioned metallurgical bond.

In another embodiment of the present invention directed to a bipolar separator plate, the at least one porous flow filed material comprises a single layer of woven wire mesh instead of the at least two layers of woven wire mesh. In this embodiment of the invention, a bipolar separator plate comprises at least one porous flow field material bonded to at least one gas barrier layer by a metallurgical bond, wherein the metallurgical bond is formed by diffusion bonding, continuous resistance welding, continuous sintering, or a combination thereof. The at least one porous flow field material comprises a single layer of woven wire mesh including warp wires and weft wires, wherein the warp wires and the weft wires are bonded together by another metallurgical bond, formed by diffusion bonding, continuous resistance welding, continuous sintering, or a combination thereof, at at least substantially all of their points of contact within the woven wire mesh.

In addition, the bipolar separator plate according to the present invention may optionally include additional components or design features that provide inlet and outlet ports for various reactants and reaction by-products.

### BRIEF DESCRIPTION OF THE DRAWINGS

FIG. 1 shows a cross-sectional schematic representation of a bipolar separator plate employing an A-B-A structure.

FIG. 2 shows a cross-sectional schematic representation of a bipolar separator plate employing an A-B-C-B-A structure.

FIG. 3 shows a cross-sectional schematic representation of an electrode flow field material.

These Figures are not necessarily drawn to scale.

### DETAILED DESCRIPTION

The present invention will now be described with reference to the illustrative embodiments in the following processes.

The present invention relates to a class of materials suitable for use as the porous flow fields in a bipolar separator plate, and to a method of producing such porous flow field materials. The present invention further relates to methods of producing a bipolar separator plate employing these porous flow field materials as components thereof, and to such bipolar separator plates which may then be incorporated into, for example, a PEMFC or a SOFC.

One embodiment of the invention relates to a method of producing a porous flow field material for a bipolar separator plate. First, at least two layers of wire mesh are positioned in a stacked arrangement. That is, the at least two layers of wire mesh are arranged one upon another to form a stack. The wire meshes for use in the invention include any wire meshes known in the art, such as for example, woven wire meshes and knitted wire meshes. Preferably, the wire meshes for use in the invention are woven wire meshes. These woven wire meshes may be of a plain or twilled weave style, and they may also be square, rectangular or Dutch weaves with respect to mesh count. In addition, these meshes may have a standard wire diameter and open area percentage, or a high open area percentage such as might be found in plain square weaves known as bolting grade meshes. For example, some meshes which may be used in accordance with the invention include, but are not limited to, bolting grade meshes having greater than 15 and fewer than 210 wires per inch, market grade plain square weave meshes having greater than 15 and fewer than 520 wires per inch, rectangular weaves, Dutch weaves permitting a high degree of lateral flow, modified plain Dutch weaves having a high ratio of warp to weft wire diameters, and modified reverse plain Dutch weaves having a high ratio of weft to warp wire diameters.

Furthermore, the at least two layers of wire mesh may each have the same or different mesh specifications. That is, the at least two layers of wire mesh may include only one type of wire mesh, or more than one type of wire mesh. For example, in one embodiment of the invention, the at least two layers of wire mesh may include meshes all arranged with parallel warp and weft wires, while in another embodiment, the meshes may be arranged in accordance with a predetermined sequence of wire meshes including various angular orientations or-biases.

In a preferred embodiment of the invention, a highly uniform and permeable porous flow field material of repeatable, isotropic and uniform geometry may be produced by properly selecting the at least two layers of woven wire mesh. That is, by specifying the layers of woven wire mesh, their weave types, mesh counts, wire diameters, and angular bias orientation with respect to successive layers, a non-random porous flow field material may be designed, whose architecture and geometry may be completely specified and are completely repeatable in production. For example, any porous flow field material in which each layer of woven wire mesh is specified as to weave style, mesh count, wire diameters, calendered thickness, angular orientation, alloy of construction, and number and sequence of layers, is a completely specified material with a uniform and repeatable non-random geometry. In this way, it is also possible to design porous flow field materials that exhibit many of the desired characteristics of permeability.

In addition, according to the present invention, the at least two layers of wire mesh may be comprised of the same or different metallic materials. Preferred metallic materials include: austenitic stainless steels, such as American Iron & Steel Institute (AISI) types 304, 304L, 316, 316L, or 347 stainless steels; alloy 904L in accordance with ASTM (UNS) N08904; nickel and its alloys, such as INCONEL® 600, MONELO 400, and certain HASTELLOY® alloys; oxygen-free high conductivity copper; phosphor bronze; and other alloys, particularly those of iron, nickel and chromium, whose composition does not contain (1) excessive amounts of aluminum (which tend to form oxides difficult to reduce and are therefore unfavorable to the process of diffusion bonding), (2) excessive potential contaminants such as sulfur and phosphorus, and (3) volatile elements with high vapor pressures and/or low melting points such as lead, cadmium and zinc. Other suitable metallic materials for use in the invention include: semi-austenitic stainless steel, such as 17-7 PH; ferritic stainless steels, such as AISI type 430; AISI type 321 or 316Ti stainless steels; oxygen-bearing coppers; brasses and bronzes; titanium; and other metals and metal alloys.

Furthermore, the wire meshes may optionally be pre-treated prior to their use in the method of the invention. For example, the meshes may be cleansed or degreased, annealed, tensioned, stretched, calendered, compressed, plated or subjected to other types of pre-treatments which are known in the art.

According to an embodiment of the method of the invention, the at least two layers of wire mesh positioned in a stacked arrangement are then bonded together to form a porous flow field material. In addition, the at least two layers of wire mesh may be calendered or compressed before, during and/or after bonding. Preferably, the at least two layers are bonded together via diffusion bonding (e.g., HIP (hot isostatic pressure) atomic diffusion bonding in a controlled atmosphere furnace), continuous resistance welding, continuous sintering, or a combination thereof. As used herein, the term “diffusion bonding” refers to the formation of a metallurgical bond by the application of sufficient heat and/or pressure to cause molecular or atomic diffusion across tangent metal surfaces. Diffusion bonding can be performed, for example, in vacuum or in a controlled atmosphere, wherein the tangent metal surfaces are kept in physical contact either by bonding, or by the application of pressure, or by gravity alone. In addition, as used herein the term “continuous sintering” refers to the formation of a metallurgical bond by a continuous application of heat, but generally at temperatures below the melting point of the metal or alloy, while the term “continuous resistance welding” refers to the formation of a metallurgical bond by a continuously applied electrical discharge whereby the metal is heated above its melting point, but only at the contact points wherein the current flow is concentrated and there is greater resistance to the flow of electrons. Furthermore, as used herein the term “metallurgical bond” refers specifically to any bond formed without the addition of any non-metallic substance or bonding agent such as an adhesive or glue, and also without the addition of any metallic bonding medium such as a solder, braze alloy, or other filler metal.

According to the invention, the bonding together of the at least two layers of wire mesh can be performed via a variety of sequences. That is, not only may all of the layers be bonded simultaneously, but two or more layers may individually be bonded together thereby forming subassemblies which may then be stacked and bonded together to form the porous flow field material. The preferred bonding sequence to be used in a particular case depends upon the characteristics of the individual layers of wire mesh, and if chosen properly, the sequence should not affect the geometry and/or properties of the individual layers of wire mesh. For example, for the bonding of a three-layer porous flow field material A-B-C comprising two heavy, coarse wire meshes (meshes B and C), and a fine surface wire mesh (mesh A), it would be preferable to bond the two coarse wire meshes (B and C) together first at a higher temperature and/or pressure and under more extreme conditions which would likely be necessary to produce a good bond between these two coarser layers. Once this two-layer subassembly of coarser, heavier meshes has been produced, then the finer surface mesh (A) could be stacked on the two-layer subassembly and bonded thereto in a separate bonding step, preferably at a lower temperature, time and/or pressure so as to minimize the risk of damaging the finer surface mesh (A) via the bonding process. However, these three layers A, B and C could also be bonded together simultaneously in one bonding step to form a porous flow field material. All such bonding sequences, including simultaneous bonding and bonding with various types of subassemblies, are within the scope of the present invention.

In another embodiment of the invention, a single layer of wire mesh may be used instead of the at least two layers of wire mesh. That is, in this embodiment of the invention, a single layer of wire mesh, preferably woven wire mesh including warp wires and weft wires, is bonded to form a porous flow field material. This bonding of a single layer of woven wire mesh comprises bonding together the warp wires and the weft wires at at least substantially all of their points of contact within the woven wire mesh. Prior to bonding, the warp wires and the weft wires are merely in contact with one another, whereas after bonding the warp wires and the weft wires are bonded together at at least substantially all of their points of contact within the woven wire mesh thereby forming the porous flow filed material. That is, the present invention includes the bonding of a single layer of woven wire mesh wherein the warp wires and the weft wires are bonded together at all of their points of contact within the woven wire mesh, and wherein the warp wires and the weft wires are bonded together at substantially all of their points of contact within the woven wire mesh (i.e., the warp wires and the weft wires need not be bonded together at every single point of contact between them within the woven wire mesh). In addition, the single layer of wire mesh is preferably bonded via diffusion bonding, continuous resistance welding, continuous sintering, or a combination thereof.

By bonding the single layer of wire mesh, or by bonding together the at least two layers of wire mesh, via diffusion bonding, continuous resistance welding, continuous sintering, or a combination thereof, the resulting porous flow field material is securely and integrally bonded in a fashion that offers excellent conductivity, while reducing resistivity. Furthermore, a properly rendered porous flow field material produced in accordance with the invention may exhibit no impairment of its metallurgical characteristics. For example, in the case of a porous flow field material produced in AISI type 316L stainless steel, it is possible to process the porous flow field material in such a way as to retain its low carbon content and prevent carbide precipitation or susceptibility to intergranular attack, and to have the porous flow field material be clean, bright, ductile and fully annealed. Such a porous flow field material could be produced by employing the correct choices of times, temperatures, atmospheres, cooling rates, cleanliness, and pre-treatments such as solvent cleaning.

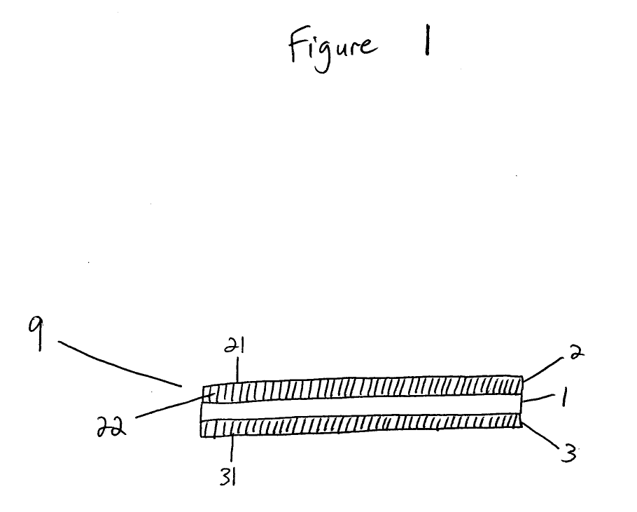

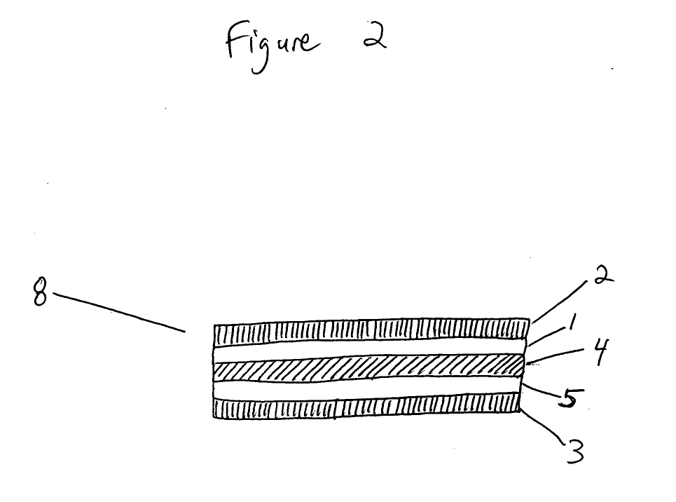

As previously described and as can be seen in FIG. 1, in an embodiment of a bipolar separator plate 9 employing a cross-sectional structure denoted by A-B-A, a gas barrier layer 1 provides a layer of separation between two porous flow fields 2, 3 on either side thereof. As was also previously described and as can be seen in FIG. 2, in another embodiment of a bipolar separator plate 8 employing a cross-sectional structure denoted by A-B-C-B-A, a third porous flow field 4, which acts as a coolant flow field, is centrally located between two gas barrier layers 1 and 5, with gas barrier layer 1 being adjacent to porous flow field 2 and gas barrier layer 5 being adjacent to porous flow field 3.

The flow fields “A” in both of the above described designs are also known variously as “electrode flow fields,” “anode and cathode flow fields,” or “current collectors.” In the second design (i.e., A-B-C-B-A), the construct B-C-B is sometimes referred to as the “bipolar plate,” while the two outer flow fields “A” are separately referred to as “current collectors.” The coolant flow field “C” of the second design is also referred to as a “coolant layer.” Thus, the term “flow field” as used herein broadly encompasses both current collectors as well as coolant layers. Furthermore, the bipolar plates according to the present invention may optionally include porous flow fields that function as current collectors or coolant layers.

According to an embodiment of the invention, the porous flow field material may be used as a coolant flow field in a bipolar separator plate, such as the coolant flow field 4 depicted in FIG. 2. For example, the porous flow field material of this embodiment may comprise three layers of plain square weave wire mesh simultaneously bonded together by a metallurgical bond, with each of the three layers of plain square weave wire mesh having warp and weft mesh counts of forty-two (42) wires per inch, the wires having a nominal diameter of 0.0055″ prior to weaving, and arranged in a repeatable sequence of angular orientations, such as for example, (0°, 45°, 0°) or (0°, 30°, 60°). Alternatively, the porous flow field material of this embodiment may comprise a single layer of plain square weave wire mesh wherein the warp wires and the weft wires are bonded together by a metallurgical bond at at least substantially all of their points of contact within the woven wire mesh, with the single layer of plain square weave wire mesh having warp and weft mesh counts of forty-two (42) wires per inch, the wires having a nominal diameter of 0.0055″ prior to weaving.

In a further embodiment of the invention, the porous flow field material useful as a coolant flow field in a bipolar separator plate may comprise layers of woven wire meshes similar to those described in the preceding paragraph, with all the layers in a 0° or parallel orientation, but with the layers including meshes of different mesh counts. For example, such a porous flow field material may comprise two outer layers of a plain square weave wire mesh having warp and weft mesh counts of forty-two (42) wires per inch, the wires having a nominal diameter of 0.0055″ prior to weaving, each of the two outer layers bonded to either side of an interstitial layer of higher or lower mesh count, such as a plain square weave wire mesh having warp and weft mesh counts of thirty (30) wires per inch, the wires having a nominal diameter of 0.0065″ prior to weaving, or alternatively, a plain square weave wire mesh having warp and weft mesh counts of fifty-two (52) wires per inch, the wires having a nominal diameter of 0.0055″ prior to weaving.

According to another embodiment of the invention, the porous flow field material may be used as an electrode flow field in a bipolar separator plate. For example, referring to FIG. 1, in an electrochemical fuel cell employing the bipolar separator plate 9, on one side of the bipolar separator plate 9 the porous flow field 2 will contact an MEA cathode (not shown), and on the other side of the bipolar separator plate 9 the porous flow field 3 will contact an MEA anode (not shown). Thus, the porous flow field 2 may be referred to as a cathode flow field, and the porous flow field 3 may be referred to as an anode flow field, or collectively they may be referred to as “electrode flow fields.”

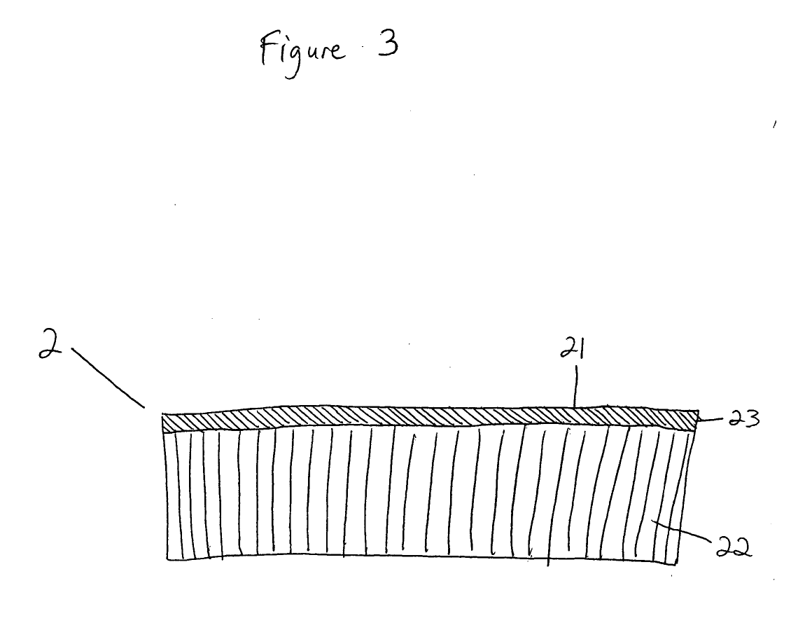

Furthermore, in an electrochemical fuel cell employing the bipolar separator plate 9, the outer planar surfaces 21, 31 of the electrode flow fields 2, 3 will be in direct contact with an MEA. Therefore, these electrode flow fields 2, 3 must not only permit lateral fluid flow within their volume, but they must also be permeable normal to their outer planar surfaces 21, 31 to allow the flow of reaction components and products (which is why electrode flow fields are often also referred to as “reactant flow fields”). That is, as can be seen in FIG. 3, the electrode flow field 2, for example, includes a porous flow field area 22, which as previously described may comprise at least two layers of woven wire mesh bonded together, which permits lateral flow (“gas distribution”). In addition, in a preferred embodiment of the electrode flow field 2, a gas diffusion layer 23 (integrally connected to the porous flow field area 22) which permits normal flow (“gas diffusion”) to the adjacent MEA surface is also included within the electrode flow field 2. The gas is distributed laterally across the area 22 of the porous flow field, and then diffuses normally through the gas diffusion layer 23. It is the addition of this gas diffusion layer 23 (which is an integral part of the electrode flow field 2) which distinguishes this preferred embodiment of the electrode flow field 2 from the coolant flow field 4 depicted in FIG. 2.

The gas diffusion layer 23, which forms the outer planar surface 21 of the electrode flow field 2, preferably also has a physical geometry that supports but does not damage the adjacent MEA. Preferably, the gas diffusion layer 23 comprises a woven wire mesh as previously described herein, wherein the mesh count of the woven wire mesh of the gas diffusion layer 23 is higher than the mesh count of the woven wire mesh of the remaining layers of the electrode flow field 2. That is, the gas diffusion layer 23 is preferably a finer mesh than that of the remaining layers of the electrode flow field 2. Because of its function, the gas diffusion layer 23 may also be referred to as an “MEA support” or a “membrane support.” The gas diffusion layer 23 preferably offers low contact resistivity at the planar interface with the MEA, and is preferably constructed of a material that offers chemical compatibility with the MEA and the electrochemical reaction, with sufficient corrosion resistance.

For example, a representative embodiment of the invention wherein the porous flow field material may be used as an electrode flow field is as follows. In this embodiment, the porous flow field material may comprise three layers of plain square weave wire mesh having warp and weft mesh counts of forty-two (42) wires per inch, the wires having a nominal diameter of 0.0055″ prior to weaving, and arranged in a repeatable sequence of angular orientations such as for example (0°, 45°, 0°) or (0°, 30°, 60°), with a further, fourth layer of plain square weave wire mesh on top of the previous three layers, having warp and weft mesh counts of one-hundred-fifty (150) wires per inch, the wires having a nominal diameter of 0.0026″ prior to weaving. In this embodiment, the three layers of plain square weave wire mesh having warp and weft mesh counts of forty-two (42) wires per inch are preferably bonded together first to form a subassembly, and then the fourth layer of plain square weave wire mesh having warp and weft mesh counts of one-hundred-fifty (150) wires per inch could be stacked on the three-layer subassembly and bonded thereto in a separate bonding step. Alternatively, the four layers could be bonded together simultaneously in one bonding step to form the porous flow field material.

Another embodiment of the invention relates to a method of producing a bipolar separator plate employing the aforementioned embodiments of porous flow field materials as components thereof, and to such bipolar separator plates. This method differs from the previously described method of producing a porous flow field material in that in this method a gas barrier layer is included as a component of the bipolar separator plate. That is, at least one gas barrier layer, which is preferably a solid metal foil, sheet or plate, and most preferably a solid metal foil less than about 0.015 inches thick, is positioned adjacent to at least one porous flow field material. A gas barrier layer and an adjacent porous flow field material are then bonded together via diffusion bonding, continuous resistance welding, continuous sintering, or a combination thereof. The exact sequence and number of gas barrier layers and porous flow field materials comprising the bipolar separator plate will vary depending upon the precise function of the resulting bipolar separator plate, and all such combinations of gas barrier layers and porous flow field materials are within the scope of the present invention.

As previously described regarding the bonding together of at least two layers of wire mesh to form a porous flow field material, the bonding together of the at least one gas barrier layer and the at least one porous flow field material can be performed via a variety of sequences. That is, not only may all of the layers (i.e., the gas barrier layer(s) and the porous flow field material(s)) be bonded simultaneously, but two or more layers may individually be bonded together thereby forming subassemblies which may then be positioned adjacent to each other and bonded together to form the bipolar separator plate. Again, the preferred bonding sequence to be used in a particular case depends upon the characteristics and functions of the individual layers. Thus, the exact bonding sequence and number of bonding steps may vary with the individual design of each bipolar separator plate, and all such bonding sequences and steps are within the scope of the present invention.

In accordance with this embodiment of the invention, the various component layers (i.e., the porous flow field material(s) and the gas barrier layer(s)) are preferably bonded together in such a way as to provide uniform contact between the component layers, uniform electrical conductivity through any cross-section of the bipolar separator plate across its functional area, and mechanical integrity. In addition, as would be understood by one of ordinary skill in the art, the method of producing the bipolar separator plate must also be compatible with the requirements of the overall design of the bipolar separator plate assembly, such that ports which permit lateral flow are not closed off during assembly, and areas that need to be sealed to flow are properly bonded in such a way as to prevent leakage. That is, the various component layers (i.e., the porous flow field material(s) and the gas barrier layer(s)) in the bipolar separator plate may optionally include design features that provide inlet and outlet ports for various reactants and reaction by-products. For example, a gas barrier layer may include one or more etched or otherwise formed channels that allow lateral fluid flow. As a further example, a porous flow field material may be configured with tabs or protrusions that function as inlet or outlet ports. In addition, the bipolar separator plate assembly may include additional metallurgically bonded components that provide these functions. Such designs of the bipolar separator plate and its components are nonetheless within the scope of the present invention.

In an embodiment of the invention, a bipolar separator plate may comprise two electrode flow fields, each bonded to one side of a gas barrier layer. Each of the two electrode flow fields may comprise three layers of plain square weave wire mesh having warp and weft mesh counts of forty-two (42) wires per inch, the wires having a nominal diameter of 0.0055″ prior to weaving, and arranged in a repeatable sequence of angular orientations such as for example (0°, 45°, 0°) or (0°, 30°, 60°), with a further, fourth layer of plain square weave wire mesh on top of the previous three layers, having warp and weft mesh counts of one-hundred-fifty (150) wires per inch, the wires having a nominal diameter of 0.0026″ prior to weaving, wherein the four layers of wire mesh are simultaneously and integrally bonded together. The gas barrier layer may comprise a thin gauge metal foil, and each of the two electrode flow fields may be bonded to opposite sides of the thin gauge metal foil such that the fourth layer of plain square weave wire mesh having warp and weft mesh counts of one-hundred-fifty (150) wires per inch (i.e., the gas-diffusion layer) of each of the two electrode flow fields forms an outside surface of the bipolar separator plate. In this embodiment, preferably each of the two electrode flow fields are produced first, and then arranged on either side of the gas barrier layer as described above. Then, the entire arrangement can be bonded together to form the bipolar separator plate.

In another embodiment of the invention, a bipolar separator plate may comprise a coolant flow field, with a gas barrier layer bonded to both sides thereof. The coolant flow field may comprise three layers of plain square weave wire mesh bonded together by a metallurgical bond, with each of the three layers of plain square weave wire mesh having warp and weft mesh counts of forty-two (42) wires per inch, the wires having a nominal diameter of 0.0055″ prior to weaving, and arranged in a repeatable sequence of angular orientations, such as for example (0°, 45°, 0°) or (0°, 30°, 60°). Each of the two gas barrier layers may comprise a thin gauge metal foil, each of which may be bonded to opposite sides of the coolant flow field. In this embodiment, preferably the coolant flow field is produced first, and then arranged between two gas barrier layers as described above. Then, the entire arrangement can be bonded together to form the bipolar separator plate.

In yet another embodiment of the invention, a bipolar separator plate may be in the form of an assembly denoted by the structure A-B-C-B-A, wherein “A” represents an electrode flow field, “B” represents a gas barrier layer, and “C” represents a suitable coolant flow field. For example, each of the two electrode flow fields may comprise three layers of plain square weave wire mesh having warp and weft mesh counts of forty-two (42) wires per inch, the wires having a nominal diameter of 0.0055″ prior to weaving, and arranged in a repeatable sequence of angular orientations such as for example (0°, 45°, 0°) or (0°, 30°, 60°), with a further, fourth layer of plain square weave wire mesh on top of the previous three layers, having warp and weft mesh counts of one-hundred-fifty (150) wires per inch, the wires having a nominal diameter of 0.0026″ prior to weaving, wherein the four layers of wire mesh are simultaneously and integrally bonded together. Each of the two gas barrier layers may comprise a thin gauge metal foil, and the coolant flow field may comprise three layers of plain square weave wire mesh bonded together by a metallurgical bond, with each of the three layers of plain square weave wire mesh having warp and weft mesh counts of forty-two (42) wires per inch, the wires having a nominal diameter of 0.0055″ prior to weaving, and arranged in a repeatable sequence of angular orientations, such as for example (0°, 45°, 0°) or (0°, 30°, 60°). In this embodiment, the two electrode flow fields and the coolant flow field are preferably produced first, and then arranged with the two gas barrier layers as described above. Then, the entire arrangement can be bonded together via diffusion bonding, continuous resistance welding, continuous sintering, or a combination thereof in order to form such a bipolar separator plate.

While the present invention is described with respect to particular examples and preferred embodiments, it is understood that the present invention is not limited to these examples and embodiments. It will be apparent to anyone skilled in the art that numerous combinations of layers of woven wire mesh, and layers of porous flow field materials and gas barrier layers, may be assembled and bonded in accordance with the present invention. A broad range of porous flow field materials and bipolar separator plates may thereby be produced, in many different metals and alloys, and with many different types and numbers of component layers, with or without various pre-treatments or post-treatments, all of which are within the scope of the present invention. For example, regarding woven wire mesh, many different combinations of weave types, mesh counts, wire diameters, numbers of layers, and orientations of layers are possible, all of which are within the scope of the present invention. The present invention as claimed therefore includes variations from the particular examples and preferred embodiments described herein, as will be apparent to one of skill in the art.

1. A method of producing a porous flow field material for a bipolar separator plate, the method comprising:
positioning at least two layers of woven wire mesh in a stacked arrangement; and
bonding together the at least two layers of woven wire mesh to form the porous flow field material, wherein the bonding together is achieved by diffusion bonding, continuous resistance welding, continuous sintering, or a combination thereof.

2. The method of claim 1, further comprising:
prior to the bonding together, positioning an additional layer of woven wire mesh on top of the at least two layers of woven wire mesh positioned in a stacked arrangement, such that the at least two layers of woven wire mesh and the additional layer of woven wire mesh are bonded together to form the porous flow field material;
wherein the additional layer of woven wire mesh has warp and weft mesh counts which are higher than the warp and weft mesh counts of the at least two layers of woven wire mesh.

3. The method of claim 1, wherein the at least two layers of woven wire mesh comprise a first layer of a first woven wire mesh and a second layer of a second woven wire mesh.

4. The method of claim 1, further comprising:
cleansing, degreasing, annealing, tensioning, stretching, calendering, compressing or plating the at least two layers of woven wire mesh prior to bonding together.

5. The method of claim 1, wherein the bonding together is achieved by diffusion bonding.

6. The method of claim 1, wherein the at least two layers of woven wire mesh comprise three layers of a plain square weave wire mesh having warp and weft mesh counts of 42 wires per inch, with wires having a nominal diameter of 0.0055″ prior to weaving and arranged in a repeatable sequence of angular orientations of (0°, 45°, 0°).

7. The method of claim 2, wherein the at least two layers of woven wire mesh comprise three layers of a plain square weave wire mesh having warp and weft mesh counts of 42 wires per inch, with wires having a nominal diameter of 0.0055″ prior to weaving and arranged in a repeatable sequence of angular orientations of (0°, 45°, 0°); and
wherein the additional layer of woven wire mesh comprises a layer of a plain square weave wire mesh having warp and weft mesh counts of 150 wires per inch, with wires having a nominal diameter of 0.0026″ prior to weaving.

8. A method of producing a porous flow field material for a bipolar separator plate, the method comprising:
bonding a single layer of woven wire mesh including warp wires and weft wires to form the porous flow field material, wherein the bonding comprises bonding together the warp wires and the weft wires at at least substantially all of their points of contact within the woven wire mesh, and wherein the bonding is achieved by diffusion bonding, continuous resistance welding, continuous sintering, or a combination thereof.

9. The method of claim 8, further comprising:
cleansing, degreasing, annealing, tensioning, stretching, calendering, compressing or plating the single layer of woven wire mesh prior to bonding.

10. The method of claim 8, wherein the bonding is achieved by diffusion bonding.

11. A porous flow field material for a bipolar separator plate, comprising:
at least two layers of woven wire mesh bonded together by a metallurgical bond, wherein the metallurgical bond is formed by diffusion bonding, continuous resistance welding, continuous sintering, or a combination thereof.

12. The porous flow field material of claim 11, further comprising:
an additional layer of woven wire mesh, such that the at least two layers of woven wire mesh and the additional layer of woven wire mesh are bonded together by the metallurgical bond;
wherein the additional layer of woven wire mesh has warp and weft mesh counts which are higher than the warp and weft mesh counts of the at least two layers of woven wire mesh.

13. The porous flow field material of claim 11, wherein the at least two layers of woven wire mesh comprise a first layer of a first woven wire mesh and a second layer of a second woven wire mesh.

14. The porous flow field material of claim 11, wherein the metallurgical bond is formed by diffusion bonding.

15. The porous flow field material of claim 11, wherein the at least two layers of woven wire mesh comprise three layers of a plain square weave wire mesh having warp and weft mesh counts of 42 wires per inch, with wires having a nominal diameter of 0.0055″ prior to weaving and arranged in a repeatable sequence of angular orientations of (0°, 45°, 0°).

16. The porous flow field material of claim 12, wherein the at least two layers of woven wire mesh comprise three layers of a plain square weave wire mesh having warp and weft mesh counts of 42 wires per inch, with wires having a nominal diameter of 0.0055″ prior to weaving and arranged in a repeatable sequence of angular orientations of (0°, 45°, 0°); and wherein the additional layer of woven wire mesh comprises a layer of a plain square weave wire mesh having warp and weft mesh counts of 150 wires per inch, with wires having a nominal diameter of 0.0026″ prior to weaving.

17. The porous flow field material of claim 15, wherein the plain square weave wire mesh comprises an austenitic stainless steel alloy.

18. The porous flow field material of claim 16, wherein the plain square weave wire mesh having warp and weft mesh counts of 42 wires per inch comprises an austenitic stainless steel alloy, and wherein the plain square weave wire mesh having warp and weft mesh counts of 150 wires per inch comprises an austenitic stainless steel alloy.

19. A porous flow field material for a bipolar separator plate, comprising:
a single layer of woven wire mesh including warp wires and weft wires, wherein the warp wires and the weft wires are bonded together by a metallurgical bond at at least substantially all of their points of contact within the woven wire mesh, wherein the metallurgical bond is formed by diffusion bonding, continuous resistance welding, continuous sintering, or a combination thereof.

20. The porous flow field material of claim 19, wherein the metallurgical bond is formed by diffusion bonding.

21. The porous flow field material of claim 19, wherein the warp wires and the weft wires comprise an austenitic stainless steel alloy.

22. A method of producing a bipolar separator plate, the method comprising:
positioning at least one gas barrier layer adjacent to at least one porous flow field material, wherein the at least one porous flow field material comprises:
at least two layers of woven wire mesh bonded together by a metallurgical bond, wherein the metallurgical bond is formed by diffusion bonding, continuous resistance welding, continuous sintering, or a combination thereof; and
bonding together the at least one gas barrier layer and the at least one porous flow field material, wherein the bonding together is achieved by diffusion bonding, continuous resistance welding, continuous sintering, or a combination thereof.

23. The method of claim 22, wherein the at least one porous flow field material further comprises:
an additional layer of woven wire mesh having warp and weft mesh counts which are higher than the warp and weft mesh counts of the at least two layers of woven wire mesh, wherein the at least two layers of woven wire mesh and the additional layer of woven wire mesh are bonded together by the metallurgical bond.

24. The method of claim 23, wherein the at least one gas barrier layer comprises a solid metal foil.

25. The method of claim 24, wherein the solid metal foil includes etched or otherwise formed flow channels.

26. The method of claim 23, wherein the at least two layers of woven wire mesh comprise a first layer of a first woven wire mesh and a second layer of a second woven wire mesh.

27. The method of claim 23, wherein the metallurgical bond is formed by diffusion bonding, and the bonding together is achieved by diffusion bonding.

28. The method of claim 23, wherein the at least two layers of woven wire mesh comprise three layers of a plain square weave wire mesh having warp and weft mesh counts of 42 wires per inch, with wires having a nominal diameter of 0.0055″ prior to weaving and arranged in a repeatable sequence of angular orientations of (0°, 45°, 0°); and wherein the additional layer of woven wire mesh comprises a layer of a plain square weave wire mesh having warp and weft mesh counts of 150 wires per inch, with wires having a nominal diameter of 0.0026″ prior to weaving.

29. A method of producing a bipolar separator plate, the method comprising:
positioning at least one gas barrier layer adjacent to at least one porous flow field material, wherein the at least one porous flow field material comprises:
a single layer of woven wire mesh including warp wires and weft wires, wherein the warp wires and the weft wires are bonded together by a metallurgical bond at at least substantially all of their points of contact within the woven wire mesh, wherein the metallurgical bond is formed by diffusion bonding, continuous resistance welding, continuous sintering, or a combination thereof; and
bonding together the at least one gas barrier layer and the at least one porous flow field material, wherein the bonding together is achieved by diffusion bonding, continuous resistance welding, continuous sintering, or a combination thereof.

30. The method of claim 29, wherein the at least one gas barrier layer comprises a solid metal foil.

31. The method of claim 30, wherein the solid metal foil includes etched or otherwise formed flow channels.

32. The method of claim 29, wherein the metallurgical bond is formed by diffusion bonding, and the bonding together is achieved by diffusion bonding.

33. A bipolar separator plate comprising:
at least one porous flow field material comprising at least two layers of woven wire mesh bonded together by a first metallurgical bond, wherein the first metallurgical bond is formed by diffusion bonding, continuous resistance welding, continuous sintering, or a combination thereof; and
at least one gas barrier layer bonded to the at least one porous flow field material by a second metallurgical bond, wherein the second metallurgical bond is formed by diffusion bonding, continuous resistance welding, continuous sintering, or a combination thereof.

34. The bipolar separator plate of claim 33, wherein the at least one porous flow field material further comprises:
an additional layer of woven wire mesh having warp and weft mesh counts which are higher than the warp and weft mesh counts of the at least two layers of woven wire mesh, wherein the at least two layers of woven wire mesh and the additional layer of woven wire mesh are bonded together by the first metallurgical bond.

35. The bipolar separator plate of claim 34, wherein the at least one gas barrier layer comprises a solid metal foil.

36. The bipolar separator plate of claim 35, wherein the solid metal foil includes etched or otherwise formed flow channels.

37. The bipolar separator plate of claim 34, wherein the at least two layers of woven wire mesh comprise a first layer of a first woven wire mesh and a second layer of a second woven wire mesh.

38. The bipolar separator plate of claim 34, wherein the first and second metallurgical bonds are formed by diffusion bonding.

39. The bipolar separator plate of claim 34, wherein the at least two layers of woven wire mesh comprise three layers of a plain square weave wire mesh having warp and weft mesh counts of 42 wires per inch, with wires having a nominal diameter of 0.0055″ prior to weaving and arranged in a repeatable sequence of angular orientations of (0°, 45°, 0°); and wherein the additional layer of woven wire mesh comprises a layer of a plain square weave wire mesh having warp and weft mesh counts of 150 wires per inch, with wires having a nominal diameter of 0.0026″ prior to weaving.

40. The bipolar separator plate of claim 38, wherein the plain square weave wire mesh having warp and weft mesh counts of 42 wires per inch comprises an austenitic stainless steel alloy, and wherein the plain square weave wire mesh having warp and weft mesh counts of 150 wires per inch comprises an austenitic stainless steel alloy.

41. A bipolar separator plate comprising:
at least one porous flow field material comprising a single layer of woven wire mesh including warp wires and weft wires, wherein the warp wires and the weft wires are bonded together by a first metallurgical bond at at least substantially all of their points of contact within the woven wire mesh, wherein the first metallurgical bond is formed by diffusion bonding, continuous resistance welding, continuous sintering, or a combination thereof; and
at least one gas barrier layer bonded to the at least one porous flow field material by a second metallurgical bond, wherein the second metallurgical bond is formed by diffusion bonding, continuous resistance welding, continuous sintering, or a combination thereof.

42. The bipolar separator plate of claim 41, wherein the at least one gas barrier layer comprises a solid metal foil.

43. The bipolar separator plate of claim 42, wherein the solid metal foil includes etched or otherwise formed flow channels.

44. The bipolar separator plate of claim 41, wherein the first and second metallurgical bonds are formed by diffusion bonding.
